(19) United States
(12) Patent Application Publication
(10) Pub. No.: US 2026/0154384 A1
(43) Pub. Date: Jun. 4, 2026

(54) SHARED ACCOUNT OBJECTS

(71) Applicant: Stripe, LLC, South San Francisco, CA (US)

(72) Inventors: Rodney Harold HOWARTH, San Francisco, CA (US); Zahra IMAN SMULLIN, Corvallis, OR (US); Natalie WEYERHAEUSER, Sausalito, CA (US); Angela JIANG, Burlingame, CA (US)

(21) Appl. No.: 18/969,164

(22) Filed: Dec. 4, 2024

(51) Int. Cl. G06F 21/31

(52) U.S. Cl. CPC G06F 21/31

(57) ABSTRACT

A user container corresponding to a user identity can include a user profile and secure object. A first user object can be added to the user container, where the first user object includes references to the user profile and secure object. One or more user roles can be established within the first user object where each role has different parameters. A reference to the first user object can be provided to a first entity. The first entity can use the reference to update the first user object in the user container directly from the first entity without updating the user profile.

### TECHNICAL FIELD

The present description generally relates to an account management system for account objects with shared attributes among various entities and managing roles associated with user accounts in relation to various entities.

### BACKGROUND

Multiple user profiles established for a user within different user contexts of an organization can result in inefficiencies and redundancy. For example, updating one user profile may cause other profiles to become out of sync. Managing different user profiles for each associated entity or user role can be cumbersome and may come with an increased risk of a data privacy breach.

### BRIEF DESCRIPTION OF THE DRAWINGS

Certain features of the subject technology are set forth in the appended claims. However, for the purpose of explanation, several embodiments of the subject technology are set forth in the following figures.

FIG. 1 illustrates an example network environment in which the subject technology may be implemented, in accordance with one or more embodiments.

FIG. 2 depicts an example electronic device that may implement the subject technology, in accordance with one or more embodiments.

FIG. 3 illustrates a data flow diagram for a process of modifying a user account associated with an organizational entity, in accordance with one or more embodiments.

FIG. 4 depicts a logic diagram illustrating relational elements of a user container and organization containers, in accordance with one or more embodiments.

FIG. 5 depicts a flow diagram of an example process for modifying a user object associated with an organization, in accordance with one or more embodiments.

FIG. 6 depicts a flow diagram of an example process for associating a user object with a first entity, in accordance with one or more embodiments.

FIG. 7 depicts an example user interface for interacting with user object associated with an organization, in accordance with one or more embodiments.

FIG. 8 depicts an example electronic system with which aspects of the present disclosure may be implemented, in accordance with one or more embodiments.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other embodiments. In one or more embodiments, structures and components are shown in block diagram form in order to avoid obscuring the concepts of the subject technology.

Modern organizations may have users associated with the organization in various roles. For example, an online retailer may have users associated with the organization as both a customer and a provider. In a simple case, it may be possible to simply use the same user object for both of these roles, but as an organization includes additional services and features, using the same user object for each of these additional services and features may be impractical if not impossible as a result of different organization requirements and infrastructure. For example, an international corporation must deal with different regulatory environments and therefore some user information may need to be siloed or otherwise protected from other aspects of the business and/or other jurisdictions. As another example, a corporation providing roles for users who receive compensation for services (e.g., providers) versus roles for users as customers may want to provide for the ability for its customers to maintain a balance with the corporation, such as by a, may have to contend with protecting user data in one context from user data in another context.

Aspects of the subject technology provide the ability to organize user accounts which are associated with an organization in a manner which utilizes a user container. The organization, for example, may instantiate a user object to be contained within a user container established for a user. The user object can inherit or include references to user information also included in the user container. In such a manner, aspects of the subject technology can access user objects associated with the organization which are logically located within the user container, which may include at least some user information securely kept separately from the organization.

Aspects of the subject technology also provide the ability to assign different roles to the same user for the organization. For example, in an organization involving content creators, a user may be assigned a role as a content creator, an end user, and an administrative user. Each of these roles may have associated therewith various parameters regarding security, file access, preferences, and so forth. As another example, in a neighborhood homeowners association, a user can be assigned a role as a board member, a member of a committee, and a homeowner or voting member. Each of these roles may have their own parameters which establish information available to the user, such as access to reports or homeowner information. As another example, a patient in a medical network may have a role as a patient of Dr. Smith, the internist, another role as a patient of Dr. Jones, the cardiologist, and another role as a patient of Dr. Rhodes, the podiatrist. While each of these doctors may be associated with their own practice, for example, the different roles of the patient under the same medical network can provide individualized user parameters for each role, while having a container for the user of the medical network. As another example, various roles can be assigned to a user account based on services or products available to the user account and provided by the organization. Each of the roles may include various parameters particular to that respective role. For example, a role as a customer may include historical information related to customer activity, order detail, shipment detail, jurisdiction information, or shipping information. The customer, however, may also have a role as a provider of similar services to other users. Some roles may require granted access by the user for some types of personal information. For example, a role as a customer may require a shipping address, while a role as a provider may require information related to identifying a legal entity corresponding to the user, e.g., user identity information, for example, for regulatory or tax reporting purposes.

Aspects of the subject technology are able to facilitate or orchestrate creating a user object associated with an organization and/or modifying an existing user object to assign various roles to the user. The facilitating of this process may include, for example, calling an application programming interface (API) to handle the request to create a user object or modify a user object to assign one or more roles to the user. The API request, for example, can be called directly by the user through a programmatic interface for the API request, in accordance with some embodiments, or may be initiated via a graphical user interface that mediates a call to the API by way of the programmatic interface. The API, in turn can orchestrate or facilitate the handling of calling various additional APIs to complete the process of creating a user object for an entity and/or modifying the user object of an entity to assign or remove roles from the user object.

In aspects of the subject technology, following the initial API request for the orchestrator or facilitator API process to add a user object for the organization and/or modify an existing user object to add or remove roles, the orchestrator or facilitator can determine which APIs are needed to be called and manage dependencies so that they are called in the correct order. In addition, the orchestrator or facilitator API process can determine what requirements each of the API calls have, determine what data is needed to fulfill the requirements, determine data sources for the required data, obtain the required data from the data sources, and prompt for any data that could not be obtained from the data sources. In some implementations, the required data can be gathered from the user information kept within the user container, for example from a user information element or by calling one or more other APIs to obtain the user information from other user objects kept within the user container, for example, another user object associated with a different organization. In some implementations, the required data can be obtained by causing a prompt to be provided on a user device for the user to provide the needed data. The prompt may be provided in real-time, e.g., during the process to add or modify the user object, or the prompt may be provided subsequent to the adding or modifying the user object, and the user may be required to provide the information prior to enabling the user to perform a certain role or activation of the modification of the user object.

Aspects of the subject technology therefore define a user container for each system user, and provide within the user container a user information element, where the user information element can store and maintain legal entity information corresponding to the system user, such as a tax ID or a government issued ID number, or the like. The user information element can also contain profile information, such as user data that may also be personally identifiable information, such as name, address, and contact information, but which may be kept at another level of security or partitioned such that a user can authorize the sharing of one type of data with an organization, but withhold sharing of another type of data with an organization. The user container may also include organization-controlled user objects. These user objects can include role definitions for the system user which are scoped specifically to that respective organization. The organization-controlled user objects can also distinguish between two different aspects of the organization which may have two different user-bases, such as a part of the organization operating in one jurisdiction and another operating in another jurisdiction, or an organization that was acquired and operating at least somewhat independently of the parent organization. Each of the organization-controlled user objects can include references to user-shared user information, such as the user profile data and/or the legal entity data. Each of the organization-controlled user objects can also include account information, such as characteristic information associated with the user such as role, access, security, profile, location, regulatory, or other information, and so forth. In some implementations, these account information aspects can be distributed from one organization to another with the user's permission. For example, during a modification operation, such as noted above, an API may be called which determines that a first profile, such as for an access control, is available in one organization user object and cause the user to be prompted to share the first profile information to another completely unrelated organization or to a related but separate organization.

Aspects of the subject technology present many advantages. As noted above, information associated with the system user in the user container can be better-controlled and established in a framework that allows flexibility for reusing user data in a regulatory compliant manner. Further, ultimate authority over a user's information is kept with the user. The orchestrator API makes provisioning a new user object or modifying an established user object more streamlined, and as a result the subject technology saves electricity, networking resources, and time.

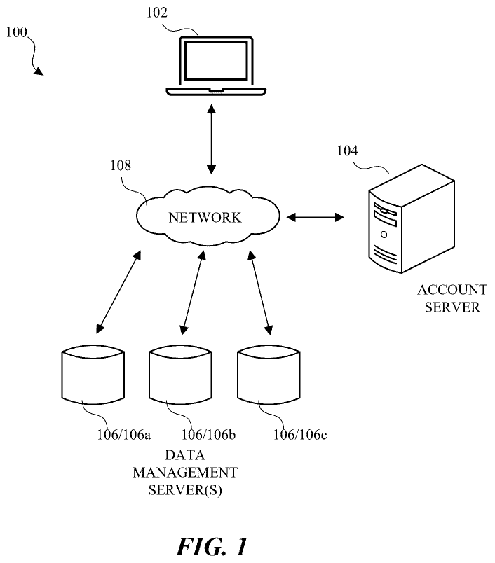

FIG. 1 illustrates an example network environment 100 in which the subject technology may be implemented, in accordance with one or more embodiments. Not all of the depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

The network environment 100 may include an electronic device 102, an account server 104, and one or more data management servers 106 such as data management server 106a, 106b, and 106c. The network 108 may communicatively (directly or indirectly) couple one or more of the electronic devices 102, the account server 104, and the one or more data management servers 106. In one or more embodiments, the network 108 may be an interconnected network of devices that may include, or may be communicatively coupled to, the internet.

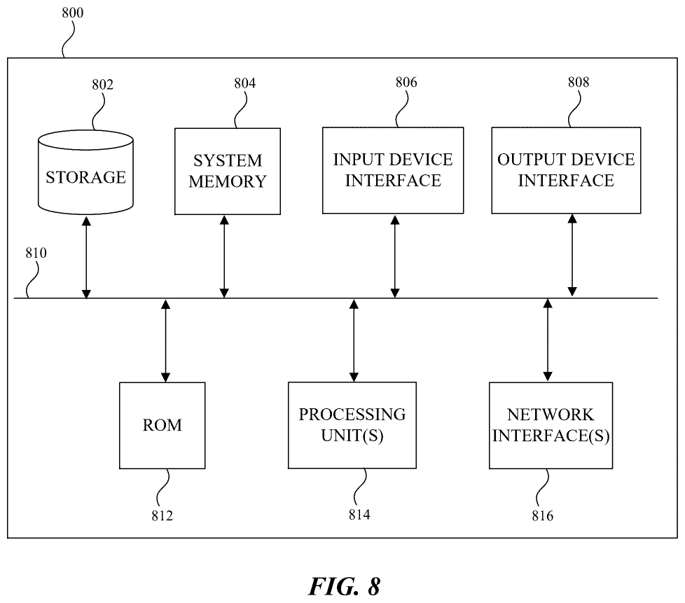

For explanatory purposes, the network environment 100 is illustrated in FIG. 1 as including the electronic device 102, the account server 104, and the one or more data management servers 106; however, the network environment 100 may include any number of electronic devices and/or any number of servers communicatively coupled to each other directly or via the network 108. In addition, the various systems of FIG. 1 may be, and/or may include all or part of, the electronic system discussed below with respect to FIG. 8.

The electronic device 102 may be under the control of a user with authorization to access records associated with the account server 104. The electronic device 102 while operating as specified herein may have authorization to interact with the account server 104 and/or the data management servers 106, for example, such as through an account login or other access credential. The electronic device 102, for example, may be associated with an administrator of an organization that manages user account roles of users associated with the organization. Thus, the electronic device 102 is used to access one or more management applications providing functionality and/or an interface for accessing the subject technology. The electronic device 102 may be, for example, a wearable device (such as a watch, a band, and the like), a desktop computer, a portable computing device (e.g., a laptop computer), a point of service terminal, a smartphone, a peripheral device (e.g., a digital camera, headphones), a tablet device, or any other appropriate device that includes, for example, one or more wireless interfaces, such as WLAN radios, cellular radios, Bluetooth radios, Zigbee radios, near field communication (NFC) radios, and/or other wireless radios. In FIG. 1, by way of example, the electronic device 102 is depicted as a laptop computer. The electronic device 102 may be associated with one or more accounts, credentials, or any other identity information registered with the account server 104 and/or the one or more data management servers 106, in accordance with some implementations.

The account server 104 may be and/or may include, for example, one or more servers that host or facilitate an application that provides management of user objects. As an example, the account server 104 may include an orchestrator API that can call other APIs to add a user object (or user container) or modify a user object associated with an organization. The account server 104 may further include application logic for determining which APIs need to be called and for determining what requirements are needed to be satisfied to drive the request to completion. The account server 104 may further include application logic to provide an interface to allow a user, such as an administrator, to retrieve and manage pending requests. In some embodiments, the account server 104 may be implemented as service of one or more servers. Such one or more servers or the account server 104 may be, and/or may include all or part of, the electronic system discussed below with respect to FIG. 8.

The one or more data management servers 106 may each be and/or may include, for example, one or more servers that host or facilitate a database service that may be used by one or more entities, such as one or more organizations, and may store and organize data related to the electronic device 102 and/or account server 104. The one or more data management servers 106 may be implemented as a service of one or more servers, such as the account server 104, or one or more other servers. Such one or more other servers or the one or more data management servers 106 may each include all or part of the electronic system discussed below with respect to FIG. 8.

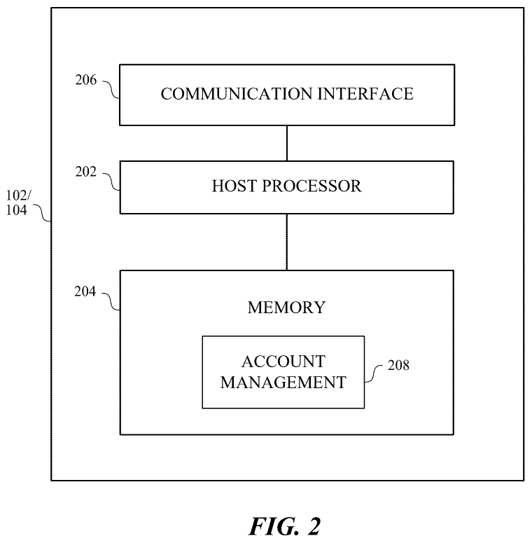

FIG. 2 depicts an example electronic device 102 or account server 104 that may implement the subject technology, in accordance with one or more embodiments. For explanatory purposes, FIG. 2 is primarily described herein with reference to the electronic device 102 or account server 104 of FIG. 1. However, this is merely illustrative, and features of the server of FIG. 2 may be implemented in any other electronic device for implementing the subject technology and/or any other server for implementing the subject technology, such as the data management servers 106. Not all of the depicted components may be used in all embodiments, however, and one or more embodiments may include additional or different components than those shown in FIG. 2. Variations in the arrangement and type of the components may be made without departing from the spirit or scope of the claims as set forth herein. Additional components, different components, or fewer components may be provided.

The electronic device 102 or account server 104 may include one or more of a host processor 202, a memory 204, and/or a communication interface 206. The host processor 202 may include suitable logic, circuitry, and/or code that enable processing data and/or controlling operations of the electronic device 102 or account server 104. In this regard, the host processor 202 may be enabled to provide control signals to various other components of the electronic device 102 and account server 104. The host processor 202 may also control transfers of data between various portions of the electronic device 102 or account server 104. The host processor 202 may further implement an operating system or may otherwise execute code to manage operations of the electronic device 102 or account server 104.

The memory 204 may include suitable logic, circuitry, and/or code that enable storage of various types of information such as received data, generated data, code, and/or configuration information. The memory 204 may include volatile memory (e.g., random access memory (RAM)) and/or non-volatile memory (e.g., read-only memory (ROM), flash, and/or magnetic storage). The memory 204 may include account manager 208 including executable programs, routines, and services that provide the functions described herein. The specific implemented account manager 208 may vary based on whether the memory 204 is implemented in the electronic device 102 or the account server 104. The memory 204, for example, can include logic and/or programming instructions for implementing part or all of the subject technology corresponding to the account manager 208.

The communication interface 206 may include suitable logic, circuitry, and/or code that enables wired or wireless communication, such as between the electronic device 102, the account server 104, the one or more data management servers 106. The communication interface 206 may include, for example, one or more of a Bluetooth communication interface, an NFC interface, a Zigbee communication interface, a WLAN communication interface, a USB communication interface, a cellular interface, or generally any communication interface.

In one or more embodiments, one or more of the host processor 202, the memory 204, the communication interface 206, and/or one or more portions thereof may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

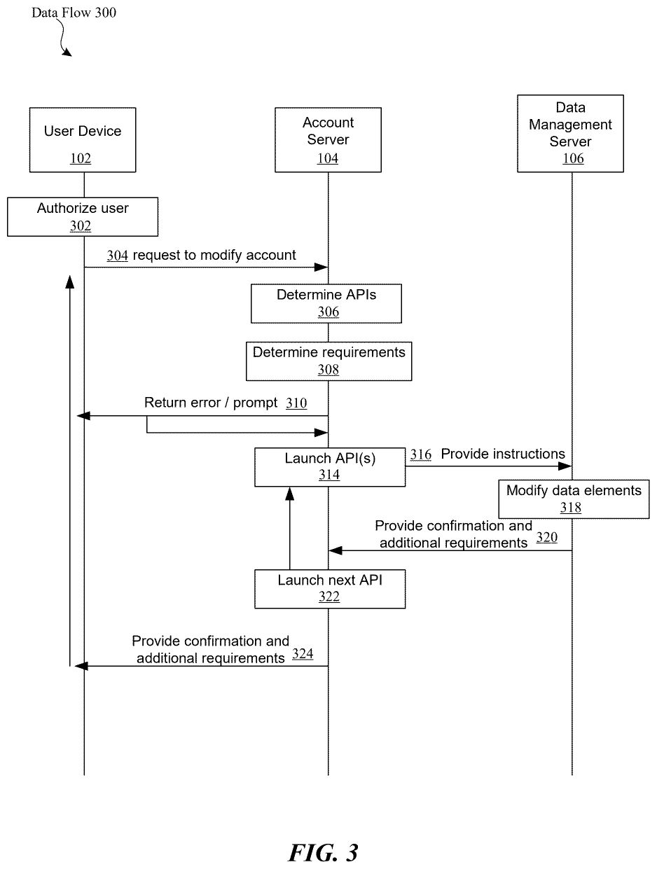

FIG. 3 illustrates a data flow diagram 300 which receives a request from a user corresponding to a request to add a user object to an organization or modify a previously established user object. The data flow diagram 300 takes place primarily in the account server 104 but sends and/or receives data from the electronic device 102 and from the one or more data management servers 106. Although the discussion of the data flow diagram 300 proceeds below describing the data flow from element to element, it should be understood that flow can be performed in parallel as appropriate or may flow out of the order described where the associated processes allow for the data flow to differ. Although specific examples may be used to help elucidate the disclosure, it should be understood that the user management described below can be applied to any situation where an administrative user would want to alter a user object associated with an organization.

At element 302, a user is authorized. In accordance with some implementations, the user in this instance may be a user controlling, for example, the electronic device 102 for administering other user accounts associated with an organization. Such other user accounts, for example, can correspond to customers, vendors, service providers, independent contractors, employees, rewards members, services members, and so forth. In accordance with other implementations, the user authorized at element 302 may correspond to one such user of the organization and the user may be in a process of self-administering their own user account information associated with the organization. In either implementation, the user may be authorized at element 302 by any suitable authorization technique verifying that the user is authorized to access a user management interface. For example, the authorization technique may include a username and password, two-factor authentication, key exchange, and so forth.

At element 304, a request to modify a user account (or add a user account) is provided to the account server 104. A paraphrase of the request may include, for example, a request to “add user John Doe as a recipient.” Here, a recipient is someone authorized to be the recipient of resources such as compensation from another user. As another example, the request may include, for example, to “add Jane Doe as a user to [the organization] and establish her as a customer and a service provider.” The request may include personal details about Jane, such as name, address, contact information, birthdate, and so forth, and business details about Jane's business as a service provider, such as license information, insurance information, accounting methods, and so forth. As noted, additional data can be gathered about Jane, from the user and/or from already known information about Jane. For example, if Jane is associated with another organization, Jane's user profile information or an access control established for one user object of an organization may be transferred from the user object for that organization to the user object for the new organization. It is contemplated, of course, that this would only be done where allowed by law and would be done in keeping with best security practices, such as by a separate authorization from the user (Jane). However, because all of Jane's user information is maintained in the user container, it is possible to provide information from one context to another context in a security-conscious manner. In some instances, some information which may be required may be left missing and the added user may be prompted to complete it or provide it later prior to enabling the user role or activation of the modification of user data. In an example where the organization is a ride-sharing company, Jane may join the organization as both a rider and a driver, for example. The request at element 304 may be received by an orchestrator API at the account server 104.

At element 306, various APIs are determined by the orchestrator API based on the operation requested. For example, if the request was to add the user account, then various onboarding APIs may be determined to be run. If the request was to add one or more roles to the user account, then APIs specific for those role set up processes would be determined to be run. As in the above example, to add a user account for Jane Doe and establish her user account as having a role corresponding to a customer and a role corresponding to a service provider, the determined APIs may include, for example, one or more of an API for creating a user container for Jane Doe, an API for creating a user information object in the user container, an API for creating a legal entity for Jane Doe within the user information object, an API for creating a user profile for Jane Doe, an API for creating a user object for the organization for Jane Doe inside the user container, an API for creating a customer role for Jane Doe in the organization profile, an API for linking the customer role for Jane Doe to the user profile in the user information object, an API for creating a service provider role for Jane Doe in the organization profile, an API for linking the service provider role for Jane Doe to the user profile in the user information object, an API for linking the service provider role for Jane Doe to the legal entity in the user information object, an API for determining access control information to associate with the customer role, or an API for providing external or personal account information to associate with the service provider role, and so forth. Utilizing an orchestrator API allows administrative users a much more simplified interface for establishing which other APIs need to be called.

It should be noted as well, that some APIs may need to be called in a particular order or may have dependencies which rely on the execution of one API prior to another API. For example, a legal entity cannot be created until a user container and a user information object are created. One API may be called before another API or vice versa, for example, when there is no dependency between the two APIs, however, each may have other dependencies such that other APIs must be called before each of these two APIs. The API orchestrator can navigate the dependencies and ensure that each of the APIs is called in an order such that the dependencies are satisfied. This advantageously provides for a more streamlined execution path. Not only are dependencies maintained among APIs, but also the order for calling the APIs, which may require a one API to be executed before another API so that the output of one API, for example, is provided as an input or pre-requisite to the call of another API. The API orchestrator, for example, can console a logic engine which analyzes the inputs provided with the request, and run through a list of registered downstream APIs to determine ordering and dependencies among the APIs based on the inputs and request.

Each of the APIs which are executed may be called from the account server 104, but the APIs themselves may be located at the account server 104 or another server, such as the data management server 106 and/or another server not shown like the account server 104 or data management server 106.

In some implementations, at element 306, the necessary APIs for accomplishing the request can be determined using an ML engine. The API orchestrator can, for example, utilize a ML engine having been trained on API request data to predict what additional APIs will be needed to be called and/or predict an order for calling the APIs. The ML engine, for example, may correspond to a large language model or another generative engine to generate content based on inputs. For example, the API orchestrator may utilize an ML engine to present the request to the ML engine to generate a predicted list of APIs to execute to accomplish the request and a predicted order for the predicted list of APIs to execute.

At element 308, the API orchestrator may determine what data requirements or, for example, what input data, is required to successfully execute the one or more APIs which were determined to be executed to effectuate the request. For example, the API orchestrator can utilize models which include all available APIs and map dependencies between the APIs. The models may also include the minimum requirements necessary to successfully execute each API or the API orchestrator can use a command at each API which will be executed to build a list of the minimum requirements, e.g., information needed, to execute each API. The requirements, for example, may correspond to the inputs from the user which are necessary to accomplish the requested task.

As an example, the user may request to add Jane Doe as a driver in a ride sharing organization, and accompanying the request provide information about Jane Doe. The information needed may vary based on whether Jane Doe is already set up as a user and the driver is a new role for Jane Doe or whether Jane Doe is being established for the first time. For example, when Jane Doe already exists as a user as a rider in the ridesharing organization, much of her information may be known, but establishing Jane Doe as a driver may require additional information, such as her birthdate, driver's license information, address, vehicle information, insurance information, and so forth.

The API orchestrator can determine if the information provided with the request at element 304 or otherwise available through Jane Doe's existing information meets the minimum requirements to fulfill the request—in this case to establish Jane Doe as a driver. This may involve, for example, establishing legal entity information for Jane Doe or establishing needed role-specific profile information, access controls to external resources, and so forth. The API orchestrator can check the requirements against the information provided along with the request at element 304. For any outstanding requirements which information was not provided, the API orchestrator can determine if such information is associated with the user account in another context, such as in association with a different user profile for another organization and determine an API call which would obtain the required information.

At element 310, if additional information is still needed to meet the requirements, then an error may be returned to the user with a description of the needed information. The user may then provide the additional information at element 304 to attempt the request again. For example, a message can be sent to the electronic device 102 for display notifying the user of the device of each missing information item of the requirements which could not be filled. In some instances, the user may be prompted to supply the needed information, upon which, the flow can continue. For example, if the electronic device 102 (e.g., the user of the electronic device 102) can provide the information via a user prompt, then the API orchestrator can update the provided information in connection with the required information and determine if the requirements were then satisfied. For example, if Jane Doe's driver's license information was required, then the API orchestrator may cause a prompt to appear at the electronic device 102 to the user to supply the needed information so that the user of the electronic device 102 could resubmit the request. Alternatively, the API orchestrator may cause a prompt to appear at the electronic device 102 to the user to supply the needed information, upon which the API orchestrator can resume operation. In such instances, the API orchestrator may cause prompts to appear as needed until all such minimal requirements are satisfied.

At element 314, the APIs can be launched. The APIs can cause, at element 316, for information to be provided to the data management server 106. In some instances, one or more of the APIs may be executed on the data management server 106, or the instructions provided to the data management server 106 may cause other APIs to be launched which are executed on the data management server 106. In the example noted above, for example, setting Jane Doe up to be a customer and a service provider, an API can establish the user container for Jane Doe, another API can establish a user profile for the organization for Jane Doe, another API can establish the customer role, another API can establish the service provider role, and so forth. As another example, the APIs may be launched for setting Jane Doe up as a driver. It is also noted that each of the APIs may be launched in such an order so that any dependencies are met for launching an API when information is needed for that API to successfully complete which is not yet available. For example, if Jane Doe is being set up as a first-time customer, then Jane Doe's user container is established before Jane Doe's user profile. Similarly, if an authorization to utilize an external resource is provided for Jane Doe, then the user profile may need to be set up first and a date of birth may need to be provided and established first to complete the authorization to utilize the external resource. The API orchestrator ensures that such dependencies are maintained so that the set-up experience is seamless to the user.

At element 318, the data elements may be modified in the data management server 106 to create the various data structures provided by executing the APIs. In some instances, a confirmation can be provided at element 320 upon completion of each API so that the next API can be executed, at element 322. In some instances, even though the minimal requirements for setting Jane Doe up as a new customer or in a new role may be provided, one or more of the APIs executed at element 314 may result in additional requirements being returned by one or more of the APIs. For example, in the case where Jane Doe is set up as a driver, a minimum requirement may be for the user at the electronic device 102 to provide a driver's license number for Jane Doe. However, to activate or enable the ability for Jane to act as a driver, a separate authorization may be required to allow Jane Doe's driving record to be checked. In such instances, where additional requirements are generated by one or more of the executed APIs, these requirements can be provided to the API orchestrator. This flow of calling or executing the APIs can be repeated until all the APIs have been executed.

At element 324 a confirmation can be provided to the electronic device 102 that the modification was successful or that the user account was successfully added. In some instances the confirmation can cause a physical change to the electronic device 102 to occur. For example, an LED light can be changed from one state to another state to signify that the flow was completed. For example, the state of an LED light in a display can be altered when the display shows a confirmation or completion message. In another example, an actuator can be triggered to cause a physical effect in the electronic device 102, such as a vibration. For example, a vibratory actuator may be triggered at the user device to notify, in part, that the flow was completed. In some implementations, the confirmation can cause the electronic device 102 to launch a web browser application or open a window in an already launched web browser application to navigate to a user profile associated with modification.

The confirmation may also include information regarding any additional requirements that were generated by the APIs that would need to be resolved to enable the user functionality or activate the change, such as enabling Jane Doe as a new customer or enabling Jane Doe as a new role as a service provider or driver. The user of the electronic device 102 may then make a new request, for example, at element 310 supplying some or all of the additional information needed to activate the change. The API orchestrator, in such instances, can continue to determine the APIs necessary to record the additional information, and execute the APIs to do so within the flow demonstrated in FIG. 3.

Aspects therefore advantageously provide a mechanism to easily modify user information associated with an organization without needing further permission from the user, without needing to know exactly which APIs will need to be executed. Aspects also advantageously leave sensitive customer data in a customer container rather than in the application itself.

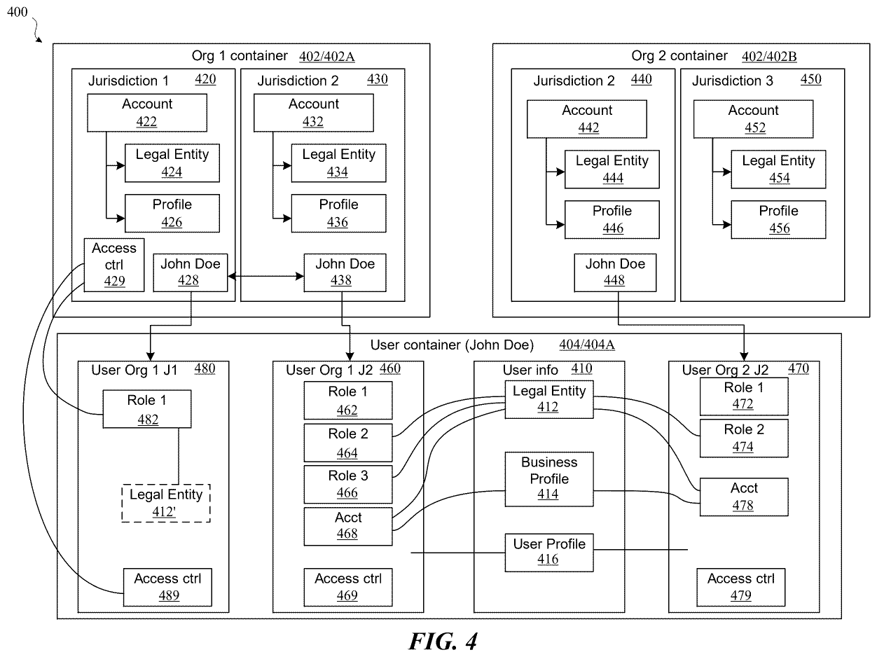

FIG. 4 illustrates a structure diagram 400 visually illustrating aspects of the data contained at the data management server 106 which is modified by the data flow and processes described herein. FIG. 4 includes organization containers, each of which can include different sub-organizations or jurisdictions associated with each overarching organization. Each of these organization containers includes information about the organization and users associated with the organizations. The user information in some instances, however, is maintained separate from the organization in its own container. Pointers or references can be provided back to the organizations to link the organization users to each of the user containers. Further, each of the user containers may include a user object therein, which has user information specific to a particular context. For example, each organization can be allowed, depending on the security settings associated with the electronic device 102, for example, to include a user object in the user container which is managed by that organization. These aspects are discussed next.

FIG. 4 illustrates an organization container 402A, an organization container 402B, and a user container 404. Each of the illustrated organization container 402A and organization container 402B represent examples of an organization container 402. Each of the organization containers 402A and 402B can logically hold aspects of separate, but related organization entities therein.

Organization container 402A, for example, includes an organization element 420 for jurisdiction 1 and an organization element 430 for jurisdiction 2. These organization elements 420 and 430, in this example, represent different legal jurisdictions of the organization corresponding to the organization container 402A, such as different countries, which may be operated separately, but which may incorporate some data sharing. For example, jurisdiction 1 may correspond to the jurisdictional entity of the organization in India and jurisdiction 2 may correspond to the jurisdictional entity of the organization in the United States. In another example, jurisdiction 1 may correspond to a particular area or specialty of the organization, which may operate at least somewhat independently of another area or specialty of the organization that corresponds to jurisdiction 2. For example, a defense contractor may maintain a sub-organization corresponding to communications technologies (e.g., jurisdiction 1) and another sub-organization corresponding to optics technologies (e.g., jurisdiction 2). Such legal jurisdictions may each have various regulatory requirements or industry best practices which necessitate the separation of the entities from one another. In the organization element 420 (i.e., for jurisdiction 1), account information 422 is provided. Account information 422 can include top-level information on the storage of funds for the entity. Further, as indicated in FIG. 4, the account information 422 can reference legal entity information 424 and profile information 426. The legal entity information 424 may include, for example, information necessary to legally identify the organization associated with the organization element 420, such as tax IDs and so forth. Profile information 426 may include additional information associated with the organization entity, such as information related to the organization, such as contact information, accounting method information, fiscal year information, and so forth. Organization element 420 further includes user references 428 for various users, including a for user John Doe. The user reference 428 for John Doe includes a user reference that points to user object 480, where user object 480 is inside a user container 404A for John Doe. The user reference 428 pointing to user object 480 is controlled by the organization element 420. Organization element 420 may also include a reference to an access control information 429. The access control information 429 may include user credentials, external account information, passkeys, biometric information, preferences, and the like. For example, the asset control information can be used to access resources of the user that are associated with a third party.

Organization element 430 may correspond to another jurisdictional aspect of the organization and may be located within the organization container 402A. The organization element 430 includes account information 432, legal entity information 434, and profile information 436. Account information 432, legal entity information 434, and profile information 436 are each similar to account information 422, legal entity information 424, and profile information 426. Organization element 430 further includes user references 438 for various users, including a for user John Doe. The user reference 438 for John Doe includes a user reference that points to user object 460, where user object 460 is inside the user container 404A for John Doe. The user reference 438 pointing to user object 460 is controlled by the organization element 430. A double-ended arrow is also pointing to both the user reference 428 within the organization element 420 and to the user reference 438 within the organization element 430. The arrow signifies that, because each of the organization element 420 and the organization element 430 are part of the organization container 402A, each may be able to obtain access, where allowed, to each other's user reference 428 and 438 to be able to access and/or control the user object 480 or user object 460 from the other organization element.

Similarly, for example, organization container 402B includes an organization element 440 for jurisdiction 2 and an organization element 450 for jurisdiction 3. By way of example, jurisdiction 2 may, again, correspond to the United States and Jurisdiction 3 may correspond to Canada. The organization element 440 includes account information 442, legal entity information 444, and profile information 446. Account information 442, legal entity information 444, and profile information 446 are each similar to account information 422, legal entity information 424, and profile information 426. Organization element 440 further includes user references 448 for various users, including a for user John Doe. The user reference 448 for John Doe includes a user reference that points to user object 470. The organization element 450 includes account information 452, legal entity information 454, and profile information 456. Account information 452, legal entity information 454, and profile information 456 are each similar to account information 422, legal entity information 424, and profile information 426. Organization element 450 does not, in this case, further include user references 448 for various users, including for user John Doe, as John Doe does not have a relationship with the organization element 450. The legal entity information, for example, may include information regarding the tax id or legal identification information for that organization in that jurisdiction. The profile information may include contact information and other data about each entity, including, for example, service level agreement information, and customer information.

The organization element 430 for jurisdiction 2 includes an example established user account John Doe corresponding to the user reference 438. The organization element 440 for jurisdiction 2 also includes user account John Doe corresponding to the user reference 448 as an established user account.

Turning now toward the bottom of FIG. 4, a user container 404, e.g., user container 404A for John Doe is illustrated. User John Doe is a user in both organizations 1 and 2, which each span multiple jurisdictions. Rather than have duplicate John Doe profiles across the two organizations, instead user container 404 representing John Doe is shared across the two organizations so that secure information is kept consistent and up to date in one place. Further, although John Doe is shared across each organization for which John Doe has a relationship, each organization and even each jurisdiction within each organization can maintain separate information particular to John Doe's relationship with that organization or jurisdiction, but maintain the separate information within the user container. Maintaining the separate user information provides each organization the ability to particularize their relationship with John Doe or specify different roles with John Doe, and also provides better user security for the user data contained within the user container.

The user container 404 includes different aspects of user data for the user. User information element 410 includes, for example, legal entity information 412 and business profile information 414. The legal entity information 412 can correspond to legal identification information for the user—in this case, John Doe. In user profiles which only have roles which do not require legal entity information, the legal entity information 412 can be omitted. For example, some organizations may not typically require a customer to legally identify themselves for the purposes of some interactions with the organization, but a contractor or service provider for such organizations may need to supply such legal information. The user information element 410 may also include basic information about the user, such as address information, contact information, demographic information, and the like.

A user object for each organization and for each jurisdiction in each organization may be defined. For example, the user object 460 for the user account for organization 1 jurisdiction 2 is provided, the user object 470 for the user for organization 2 jurisdiction 2 is provided, and the user object 480 for the user for organization 1 jurisdiction 1 is provided. Notably, each of the John Doe users references 438 and 448 include references to the user objects 460 and 470. These user objects are contained and maintained within the user container 404A for John Doe, but the organizations having references to these user objects 460 and 470 are allowed access to them and write to or modify them.

Each of the user objects 460, 470, and 480 define particular roles and information provided in the user objects. User object 460, for example includes role 1 (462), role 2 (464), and role 3 (466). In this example, role 1 (462) may correspond to a customer role, role 2 (464) may correspond to a recipient role, and role 3 (466) may correspond to a provider role. For example, a role as a rider of a ride-sharing service may correspond to a customer role while a role as a driver of a ride-sharing service may correspond to a provider role. As another example, a user in an organization may have a role as an employee, a role as a manager, and a role as a trainer. User object 470, for example includes role 1 (472) and role 2 (474). In this example, role 1 (472) may correspond to a customer role and role 2 (474) may correspond to a recipient role. User object 480, for example, includes role 1 (482) alone. In this example, role 1 (482) may correspond to a customer role.

Some of the roles may require additional information to effectuate the role. For example, if a user account has a service provider role associated with the user object, then the user account may have a second account associated with an institutional object to enable the user to receive compensation for the services provided. In FIG. 4, for example, user objects 460 and 470 each have accounts 468 and 478, respectively, associated with the institutional object associated with business profile information 414. The institutional accounts may be used to provide movement of funds to the user.

As noted in FIG. 4, the user objects 460 and 470 contain example references that point to the legal entity information 412, the business profile information 414, and the user profile information 416. As such, these roles may utilize the information from the user information element 410 rather than keep copies. Since this data is sensitive and can contain personal details, then this data can be prevented from being stored in association with the organization and rather is maintained and stored in the user container 404.

Each of the user objects 460, 470, and 480 may also include access control information 469, 479, and 489, respectively, where an access control includes a user resource available to the user objects, for example, to one or more of the defined roles. An access control, for example, can include user credentials, external account information, passkeys, biometric information, preferences, and the like. The access control information 469, 479, and 489 can correspond to, for example, an access control to access resources at a third-party saved for use in each organization for use by the user in the customer role or other appropriate roles. For example, in the customer role, an access control, such as access control information 469 can be used to access resources necessary to complete a process associated with being a customer in the customer role. In another role, per use cost or subscription costs associated with the role, for example, may be provided for via the access control associated with the access control information 469, 479, and/or 489, respectively. Each of the access control information 469, 479, and/or 489 may correspond to the same access control or may correspond to distinct access controls.

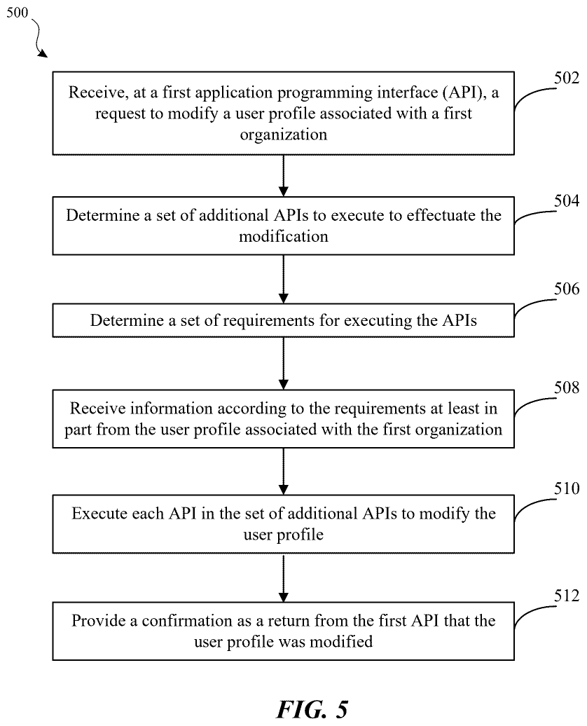

FIG. 5 illustrates a flow diagram of an example process 500 for providing from at a server, such as the account server 104, a mechanism for processing requests from users, such as from an electronic device 102, in accordance with the subject technology, to add or modify user profiles. For explanatory purposes, the process 500 is primarily described herein with reference to the account server 104. However, the process 500 is not limited to these, and one or more blocks of the process 500 may be performed by one or more other by other suitable devices. Further, for explanatory purposes, the blocks of the process 500 are described herein as occurring sequentially or linearly. However, multiple blocks of the process 500 may occur in parallel. In addition, the blocks of the process 500 need not be performed in the order shown and/or one or more blocks of the process 500 need not be performed and/or can be replaced by other operations.

At block 502, an application server can receive, at a first application programming interface (API), a request to modify a user object associated with a first organization. The request may come, for example, from an authenticated user at a user device, such as the electronic device 102. The request can be a request, for example, to modify a user object to add a user role with the organization. For example, the request can include a request to add a new role corresponding to a role as a recipient, a role as a holder of resources, a role as service provider, or a role as a customer. In some instances, the modification may be to add access control information or update other user information associated with the user at the organization. In one or more implementations, block 502 can correspond to element 304 of FIG. 3.

At block 504 of process 500 the application server determines a set of additional APIs to execute to effectuate the modification. The application server for example can determine from the request and information provided with the request which APIs need to be called in order to make the requested modification. Examples of such API requests are provided above; however, it should be appreciated that the APIs called can be organized in a variety of ways to accomplish the modification. In one or more implementations, block 504 can correspond to element 306 of FIG. 3.

At block 506 of process 500, the application server determines a set of requirements for executing the APIs. In one or more implementations, block 506 can correspond to element 308 of FIG. 3, described above. The application server, for example, can compare the information provided with the request with the information required by the API calls that were determined at block 504. The application server can then, for example, determine which requirements need additional information to be satisfied. In some implementations, such as at block 508 of process 500, the application server can receive information according to the requirements at least in part from the user object associated with the first organization. In such implementations, for example, if the user object already has a role within the organization, the application server can access user information from another role within the organization. If information is still needed, the application server can next try to determine if the needed information is available in another part of the user container which can be accessed for fulfilling the requirement. If information is still needed after that, the electronic device 102 can be prompted to provide the information. For example, receiving information according to the requirements may include receiving information from a user device corresponding to the request.

At block 510 of process 500, the application server can execute each API in the set of additional APIs to modify the user object. As noted above, the APIs can be executed in an order that accounts for dependencies from one API call to the next, as needed. For example, executing each API may be performed in a particular order, where the order is based at least in part on a dependency of a second API on data generated by a first API. For example, the second API may correspond to a process of adding an access control to a user object after a role related to the access control has been established. As each API call is executed, a data management server can update user container and/or user profile information according to the modification(s) being made. In one or more implementations, block 510 can correspond to elements 314, 316, 318, 320, and 322 of FIG. 3, described above. In some implementations, one or more of the APIs can also return a list of requirements or information needed to fully enable the requested modification to the user. For example, if a modification request is to add a new role for a user, then the role may be added using minimum necessary requirements, but additional information may be needed to fully enable functionality associated with the new role. For example, if a user is adding a role as a service provider, then the user may supply legal entity information, for example, for tax purposes, but a system may also require the user to demonstrate proof of insurance or provide a driver's license number or expiration date in order to utilize their role as a service provider.

At block 512 of process 500, the application server can provide a confirmation as a return from the first API that the user object was modified. In some implementations, the confirmation can include a message that additional information is needed to enable the user role or activate the modification of user data, for example, when a one or more APIs of the set of additional APIs that is called by the first API indicates that additional information is needed to enable or activate the modification, such as additional information needed to enable a new user role. In one or more implementations, block 512 can correspond to element 324 of FIG. 3, described above. In some implementations, the process can continue back to block 502 so that a user can supply the additional information needed to activate the modification, for example, in a new request to supply the additional information.

In some implementations, the user object may correspond to a first user object of a user container, where the first user object is controlled by the first organization, where the first user object includes one or more references to a legal entity of a user or user information of the user, where executing each API causes a modification to occur in the first user object to add a role to the a first user object, wherein the role includes a reference to the legal entity of the user. For example, the reference may provide legal entity information of the user to the organization on an as-needed basis and based on the user role without copying the legal entity information to the organization.

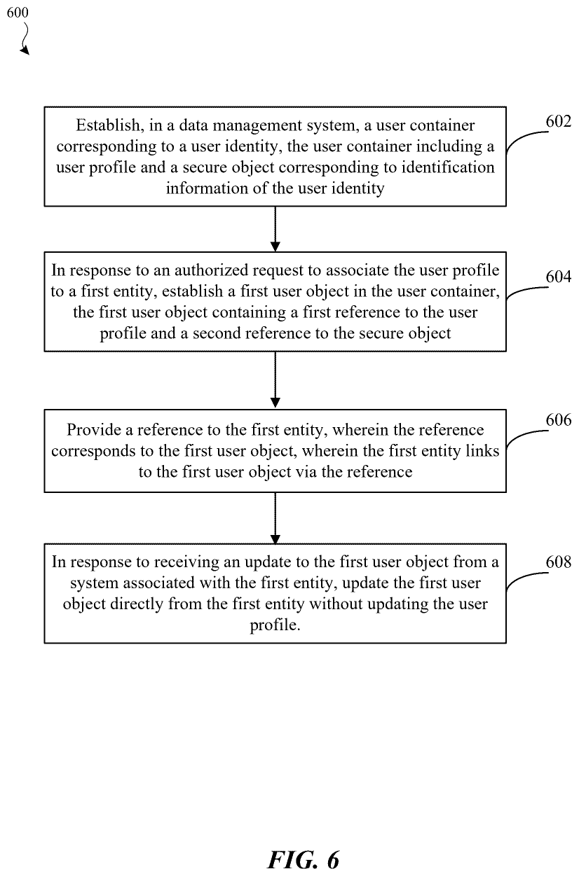

FIG. 6 illustrates a flow diagram of an example process 600 for providing from a server, such as the account server 104, a mechanism for processing requests from users, in accordance with the subject technology. For explanatory purposes, the process 600 is primarily described herein with reference to the account server 104. However, the process 600 is not limited to these, and one or more blocks of the process 600 may be performed by one or more other by other suitable devices. Further, for explanatory purposes, the blocks of the process 600 are described herein as occurring sequentially or linearly. However, multiple blocks of the process 600 may occur in parallel. In addition, the blocks of the process 600 need not be performed in the order shown and/or one or more blocks of the process 600 need not be performed and/or can be replaced by other operations.

At block 602, process 600 may include establishing, in a data management system, a user container, such as the user container 404 of FIG. 4, corresponding to a user identity, the user container including a user profile, such as the user profile information 416, and a secure object, such as the legal entity information 412, corresponding to identification information of the user identity. The user container, for example, can include a user information element, such as the user information element 410 which includes the user profile and the secure object.

At block 604, process 600 may include, in response to an authorized request to associate the user profile to a first entity, such as the organization element 430 of FIG. 4, establishing a first user object, such as the user object 460, in the user container, the first user object containing a first reference to the user profile and a second reference to the secure object. The first reference, for example, can correspond to a reference from the first user object for the first entity to a user profile in the user container. The second reference, for example, can correspond to a reference from a role or other element of the user object to the secure object in the user container. As an example of a secure object, the legal entity information in the user container, can be provided to the user object to access by the reference, but not to copy.

At block 606, process 600 may include providing a reference to the first entity, wherein the reference corresponds to the first user object, wherein the first entity links to the first user object via the reference. The reference provided to the first entity, for example, may include an ID or memory address for the user object in the user container. In some implementations, the reference may also include an access provision, such as a token exchange to verify that the first entity has access to the user object in the user container corresponding to the first entity. In such implementations, a token can be provided to the first entity when the first user object is established, where the token allows the first entity to access the first user object for reading the first user object or writing to the first user object. In some implementations, the token provided to the first entity can include a read token and a write token, and the first entity can use the read token when a read-only operation is used and the write token when the record associated with the user information for the first entity is incorrect. For example, in response to a request to access the first user object, the system can verify that the request is coming from an entity associated with the first user object. Recall that the first user object was established when the user became associated with the entity. In that process, a token can be generated and provided to the entity. In implementations using a toke, every subsequent request to read or modify the user object must include a token. The system can verify that the token is valid and provide a response or execute the modification as requested. Recall that because the user object is established by the entity within the user container, the user maintains first-hand authority over their data. In other words, the user can access their data directly without the entity if desired. One advantage in aspects that utilize a token includes that if the user revokes the token, then the token supplied by the entity in attempting to access a user object can be broken. Thus, in some implementations, a user can revoke a token corresponding to the reference such that the reference is effectively broken, for example, as a data privacy protection measure.

At block 608, process 600 may include, in response to receiving an update to the first user object from a device associated with the first entity, updating the first user object directly from the first entity without updating the user profile. For example, the reference between the first entity and the user object can be used to control and/or update aspects of the user object from the first entity. A user may also be able to control and/or update the user object also, but implementations advantageously provide for the first entity to control and/or update the user object while the user object itself is logically located within the user container which is maintained, not under the control of the entity (or organization), but under the control of the user. For example, as noted above, the user can revoke the reference from the first entity to the user object, if desired.

Process 600 may further include in some implementations, establishing one or more roles within the first user object, each role of the one or more roles respectively includes a set of parameters associated with the respective role. Roles may be provided for use in the user objects, such as described in greater detail above.

Process 600 may also include in some implementations, in response to an authorized request to associate the user profile to a second entity, establishing a second user object in the user container, the second user object containing a third reference to the user profile and a fourth reference to the secure object, and establishing one or more roles within the second user object, each role of the one or more roles respectively comprising a set of parameters associated with the respective role.

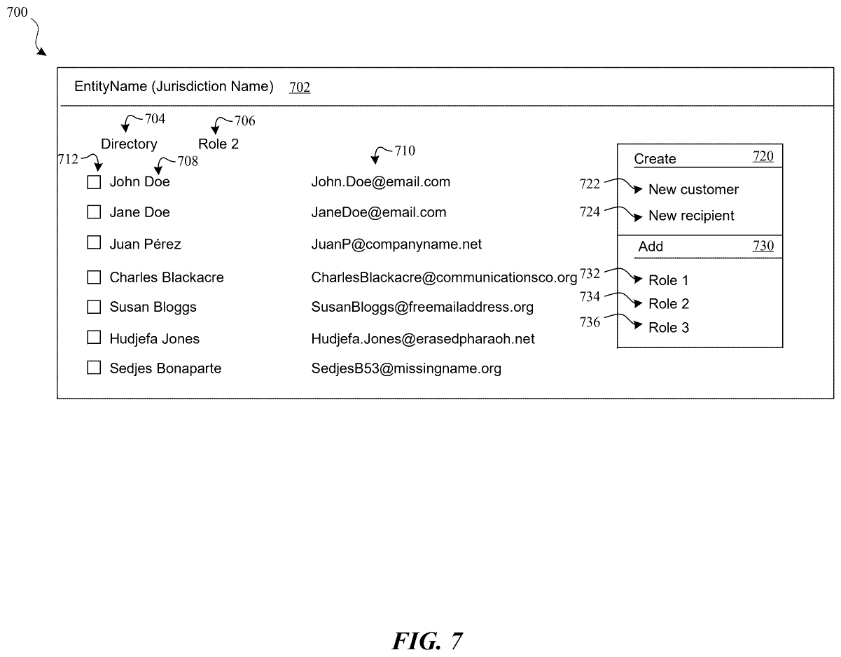

Process 600 may also include in some implementations, receiving, via a user interface, such as one described below with respect to FIG. 7, an instruction to list available users associated with the first entity, filtering the list of available users according to a role associated with the first user object, and receiving, via the user interface, a selection of a first user and a first action to add a different role to the first user object.

FIG. 7 illustrates an example interface 700 for managing user accounts associated with the account server 104. In some implementations, the interface 700 may be provided by the account server 104, for example, to the electronic device 102. The interface 700 includes a management interface for a particular entity and a particular jurisdiction within the entity. While the jurisdiction may refer, for example, to the country in which the entity is associated, it should be understood, however, that jurisdiction may correspond instead to another sub-entity within the entity. The interface may display the entity name and jurisdiction information at element 702. Element 704 may refer to a tool-type for the management interface. In the example illustrated in FIG. 7, the interface is a directory interface. The management interface may include additional interfaces, such as a profile detail interface. The interface may further include filters 706 which can be applied to display a subset of available user accounts in the directory according to the applied filter. In the example of FIG. 7, only those user accounts with an assigned Role 2 are displayed. For example, Role 2 can correspond to a role of being a recipient. A listing of names 708 corresponding to the selected filter is provided. Additional information, such as contact information 710 may be provided. In the illustrated implementation, the contact information 710 corresponds to email addresses, however, phone numbers, IP addresses, home and/or work addresses, or the like may be provided instead or in addition. Each line of the directory listing may include a selection mechanism 712, such as the illustrated checkboxes, however, selection mechanism 712 may include other selection elements.

To the right of the interface in this example, various tools are provided, for example, to create 720 a new customer 722 or a new recipient 724. If selected, the selection can correspond to a request such as provided and discussed above with respect to the data flow diagram 300 of FIG. 3, at element 304. In particular, the interface may be for a particular entity, such as the organization associated with organization container 402B. If the new customer 722 tool is selected, then a form may appear that includes a request for typical information for a new customer registration, such as basic contact information. Upon submission of the form, the form may be sent to the API orchestrator. The API orchestrator can determine which APIs need to be executed. For example, the API orchestrator may have a set of definitions for which APIs should be launched, where each entity has their own defined set of APIs parameters for establishing a new customer. The API orchestrator may determine for example, if the customer is already established and therefore already has a customer container. If the customer is not already established, the API orchestrator can call an API to establish a customer, including creating a customer container for the customer data. If the customer is already established or following the establishment of the customer, including the customer's associated customer container, then the API orchestrator can call an API to create a user object, such as the user object 460, corresponding to the organization. Then, the API orchestrator can call various APIs to populate the user object with data from the form. At least one of the APIs can provide an access token back to the first entity for storing, in accordance with some implementations.

Another tool is to add a new role 730 to an existing user account, for example, the role 1 (732), the role 2 (734), or the role 3 (736). When a user account is selected with the selection mechanism 712, and the role 2 (734) is selected, then an API orchestrator can be launched to begin a process of adding a role, such as described above. For example, the API orchestrator can determine whether the requested role depends on other roles, and if so, determine which APIs should be called. The initial decision about which APIs to be called may be determined via a logic map provided to the API orchestrator. In some implementations, the API orchestrator can query the other APIs for the information required. As noted above, the information can be obtained from the request, from other user objects within the user container, or via a prompt to the user for the missing information. The API orchestrator can call an API adding the role to the user object, followed by calling API to populate the roll with roll-specific parameters. For example, if the role being added was to add to a customer of a ride-sharing service, a role as a service provider, then the API orchestrator may determine that the user object does not currently have a legal entity associated therewith, and so an API may need to be called to establish the legal entity information in the user object. Similarly, the API orchestrator may determine that vehicle type information was not provided for the user. In response, the API orchestrator may finish the enrollment process, except mark the role as inactive, pending the user providing the missing vehicle information via the user interface.

It should be understood, of course, that the interface 700 is merely an example of an interface. Using the interface 700 can cause the API orchestrator to be launched, for example, by generating requests submitted to the API orchestrator through the interface 700.

FIG. 8 depicts an example electronic system 800 with which aspects of the present disclosure may be implemented, in accordance with one or more embodiments. The electronic system 800 can be, and/or can be a part of, any electronic device for generating the features and processes described in reference to FIGS. 1-8, including but not limited to a laptop computer, tablet computer, smartphone, and wearable device (e.g., smartwatch, fitness band). The electronic system 800 may include various types of computer-readable media and interfaces for various other types of computer-readable media. The electronic system 800 includes one or more processing unit(s) 814, a persistent storage device 802, a system memory 804 (and/or buffer), an input device interface 806, an output device interface 808, a bus 810, a ROM 812, one or more processing unit(s) 814, one or more network interface(s) 816, and/or subsets and variations thereof.

The bus 810 collectively represents all system, peripheral, and chipset buses that communicatively connect the numerous internal devices of the electronic system 800. In one or more embodiments, the bus 810 communicatively connects the one or more processing unit(s) 814 with the ROM 812, the system memory 804, and the persistent storage device 802. From these various memory units, the one or more processing unit(s) 814 retrieves instructions to execute and data to process in order to execute the processes of the subject disclosure. The one or more processing unit(s) 814 can be a single processor or a multi-core processor in different embodiments.

The ROM 812 stores static data and instructions that are needed by the one or more processing unit(s) 814 and other modules of the electronic system 800. The persistent storage device 802, on the other hand, may be a read-and-write memory device. The persistent storage device 802 may be a non-volatile memory unit that stores instructions and data even when the electronic system 800 is off. In one or more embodiments, a mass-storage device (such as a magnetic or optical disk and its corresponding disk drive) may be used as the persistent storage device 802.

In one or more embodiments, a removable storage device (such as a floppy disk, flash drive, and its corresponding disk drive) may be used as the persistent storage device 802. Like the persistent storage device 802, the system memory 804 may be a read-and-write memory device. However, unlike the persistent storage device 802, the system memory 804 may be a volatile read-and-write memory, such as RAM. The system memory 804 may store any of the instructions and data that one or more processing unit(s) 814 may need at runtime. In one or more embodiments, the processes of the subject disclosure are stored in the system memory 804, the persistent storage device 802, and/or the ROM 812. From these various memory units, the one or more processing unit(s) 814 retrieves instructions to execute and data to process in order to execute the processes of one or more embodiments.

The bus 810 also connects to the input device interfaces 808 and output device interfaces 808. The input device interface 806 enables a user to communicate information and select commands to the electronic system 800. Input devices that may be used with the input device interface 806 may include, for example, alphanumeric keyboards, touch screens, and pointing devices. The output device interface 808 may enable the electronic system 800 to communicate information to users. For example, the output device interface 808 may provide the display of images generated by electronic system 800. Output devices that may be used with the output device interface 808 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more embodiments may include devices that function as both input and output devices, such as a touchscreen. In these embodiments, feedback provided to the user can be any form of sensory feedback, such as visual feedback, auditory feedback, or tactile feedback; and input from the user can be received in any form, including acoustic, speech, or tactile input.

The bus 810 also couples the electronic system 800 to one or more networks and/or to one or more network nodes through the one or more network interface(s) 816. In this manner, the electronic system 800 can be a part of a network of computers (such as a local area network, a wide area network, an intranet, or a network of networks, such as the internet). Any or all components of the electronic system 800 can be used in conjunction with the subject disclosure.

Embodiments within the scope of the present disclosure can be partially or entirely realized using a tangible computer-readable storage medium (or multiple tangible computer-readable storage media of one or more types) encoding one or more computer-readable instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more embodiments, the tangible computer-readable storage medium can be directly coupled to a computing device, while in other embodiments, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more embodiments are performed by one or more integrated circuits, such as ASICs or FPGAs. In one or more embodiments, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be re-arranged, or that all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together into a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more embodiments, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, an embodiment, the embodiment, another embodiment, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
establishing, in a data management system, a user container corresponding to a user identity, the user container including a user profile and a secure object corresponding to identification information of the user identity;
in response to an authorized request to associate the user profile to a first entity, creating a first user object in the user container, the first user object containing a first reference to the user profile and a second reference to the secure object; and
providing a reference to the first entity, wherein the reference corresponds to the first user object, wherein the first entity links to the first user object via the reference; and
in response to receiving an update to the first user object from a system associated with the first entity, updating the first user object directly from the first entity without updating the user profile.

2. The method of claim 1, further comprising:
establishing one or more roles within the first user object, wherein each role of the one or more roles respectively comprises a set of parameters associated with the respective role and wherein each role of the one or more roles has different parameters.

3. The method of claim 1, further comprising:
in response to an authorized request to associate the user profile to a second entity, establishing a second user object in the user container, the second user object containing a third reference to the user profile and a fourth reference to the secure object; and
establishing one or more roles within the second user object, each role of the one or more roles respectively comprising a set of parameters associated with the respective role.

4. The method of claim 3, further comprising:
copying an access control from the first user object to the second user object, wherein the access control corresponds to a credential authorizing access to a third-party system.

5. The method of claim 1, further comprising:
establishing an access control in the first user object for use by a role defined within the first user object to access a resource associated with a third-party system.

6. The method of claim 1, further comprising:
in response to receiving an instruction to revoke the reference provided to the first entity, revoking a token associated with the reference.

7. The method of claim 1, further comprising:
receiving, via a user interface, an instruction to list available users associated with the first entity;
filtering the list of available users according to a role associated with the first user object; and
receiving, via the user interface, a selection of a first user and a first action to add a different role to the first user object.

8. The method of claim 1, wherein the user profile and the secure object are defined within a user identification object in the user container.

9. A device comprising:
a storage device; and
a processor configured to:
establish, in a data management system, a user container corresponding to a user identity, the user container including a user profile and a secure object corresponding to identification information of the user identity;
in response to an authorized request to associate the user profile to a first entity, create a first user object in the user container, the first user object containing a first reference to the user profile and a second reference to the secure object;
provide a reference to the first entity, wherein the reference corresponds to the first user object, wherein the first entity links to the first user object via the reference; and
in response to receiving an update to the first user object from a system associated with the first entity, update the first user object directly from the first entity without updating the user profile.

10. The device of claim 9, wherein the processor is further configured to:
establish one or more roles within the first user object, wherein each role of the one or more roles respectively comprises a set of parameters associated with the respective role and wherein each role of the one or more roles has different parameters.

11. The device of claim 9, wherein the processor is further configured to:
in response to an authorized request to associate the user profile to a second entity, establish a second user object in the user container, the second user object containing a third reference to the user profile and a fourth reference to the secure object; and
establish one or more roles within the second user object, each role of the one or more roles respectively comprising a set of parameters associated with the respective role.

12. The device of claim 11, wherein the processor is further configured to:
copying an access control from the first user object to the second user object, wherein the access control corresponds to a credential authorizing access to a third-party system.

13. The device of claim 9, wherein the processor is further configured to:
establishing an access control in the first user object for use by a role defined within the first user object to access a resource associated with a third-party system.

14. The device of claim 9, wherein the processor is further configured to:
in response to receiving an instruction to revoke the reference provided to the first entity, revoke a token associated with the reference.

15. The device of claim 9, wherein the processor is further configured to:
receive, via a user interface, an instruction to list available users associated with the first entity;
filter the list of available users according to a role associated with the first user object; and
receive, via the user interface, a selection of a first user and a first action to add a different role to the first user object.

16. The device of claim 9, wherein the user profile and the secure object are defined within a user identification object in the user container.

17. A non-transitory computer-readable medium storing a set of instructions, the set of instructions comprising:
one or more instructions that, when executed by one or more processors of a device, cause the device to:
establish, in a data management system, a user container corresponding to a user identity, the user container including a user profile and a secure object corresponding to identification information of the user identity;
in response to an authorized request to associate the user profile to a first entity, create a first user object in the user container, the first user object containing a first reference to the user profile and a second reference to the secure object; and
provide a reference to the first entity, wherein the reference corresponds to the first user object, wherein the first entity links to the first user object via the reference; and
in response to receiving an update to the first user object from a system associated with the first entity, update the first user object directly from the first entity without updating the user profile.

18. The non-transitory computer-readable medium of claim 17, wherein the one or more instructions further cause the device to:
establish one or more roles within the first user object, wherein each role of the one or more roles respectively comprises a set of parameters associated with the respective role and wherein each role of the one or more roles has different parameters.

19. The non-transitory computer-readable medium of claim 17, wherein the one or more instructions further cause the device to:
in response to an authorized request to associate the user profile to a second entity, establish a second user object in the user container, the second user object containing a third reference to the user profile and a fourth reference to the secure object; and
establish one or more roles within the second user object, each role of the one or more roles respectively comprising a set of parameters associated with the respective role.

20. The non-transitory computer-readable medium of claim 17, wherein the one or more instructions further cause the device to:
in response to receiving an instruction to revoke the reference provided to the first entity, revoke a token associated with the reference.
